(19) United States
(12) Patent Application Publication
(10) Pub. No.: US 2026/0208573 A1
(43) Pub. Date: Jul. 23, 2026

(54) HYDROGEN POWERTRAIN

(71) Applicant: AMPERE S.A.S., Boulogne Billancourt (FR)

(72) Inventors: David GERARD, Guyancourt Cedex (FR); Cedric LIBERT, Guyancourt Cedex (FR)

(73) Assignee: AMPERE S.A.S., Boulogne Billancourt (FR)

(21) Appl. No.: 19/140,076

(22) PCT Filed: Dec. 7, 2023
(86) PCT No.: PCT/EP2023/084724

§ 371 Date: Jun. 17, 2025

(30) Foreign Application Priority Data
Dec. 20, 2022 (FR) FR2213963

(51) Int. Cl. B60K 6/32; B60K 6/24; B60K 6/28; B60K 13/02; B60K 15/03; H01M 8/04746

(52) U.S. Cl. CPC B60K 6/32; B60K 6/24; B60K 6/28; B60K 13/02; B60K 15/03006; H01M 8/04776; B60K 2015/03315

(57) ABSTRACT

A powertrain that operates with hydrogen includes a hydrogen tank, an internal combustion engine supplied with hydrogen by the hydrogen tank, and an electric motor operating from a fuel cell supplied with hydrogen from this hydrogen tank. The powertrain includes an air-circulation connection circuit provided with an opening/closing device and connecting an air outlet of the fuel cell to an air inlet of the internal combustion engine to allow oxygen-depleted air from the fuel cell to supply the internal combustion engine.

The present invention concerns a hydrogen powertrain.

The invention thus concerns the technology of hydrogen propulsion and the use of the best means of transforming this energy in order to propel a motor vehicle.

The solutions currently known are the use of a fuel cell system coupled to a battery, in particular for managing the start-up and transitory operating modes. Other possible solutions consist of combusting the hydrogen in an internal combustion engine. Both these solutions naturally imply the need to store the hydrogen in the vehicle in the form of pressurized cylinders, for example.

The advantages of the “fuel cell” solution are in particular a very high efficiency at the partial loads corresponding to low power levels, and the generation of an electrical power which can be used in an electric motor to propel the vehicle without any legislatively restricted polluting emissions.

The advantages of the “internal combustion engine” solution are in particular the ability to generate high power with a high efficiency corresponding to high loads of the internal combustion engine. However, the internal combustion engine produces small quantities of legislatively restricted pollutants.

In order to be able to benefit from the advantages associated with each of these solutions, the two have been combined within a powertrain of a vehicle.

Thus, the powertrain combining the two solutions includes:
a hydrogen storage system comprising an interface for filling, and allowing the supply of hydrogen to the internal combustion engine and to the fuel cell,
an internal combustion engine operating with hydrogen and connected to the transmission axle, allowing propulsion of the vehicle. The engine is supplied with hydrogen by the hydrogen storage system,
an electric motor connected to the transmission axle, allowing propulsion of the vehicle. The electric motor is supplied with electricity by a buffer battery and by a fuel cell system which is supplied by the hydrogen storage system.

With respect to the need to supply air to this powertrain, it should be specified that the two elements of the internal combustion engine and the fuel cell must each be supplied with air during their operation.

It is then possible to consider a first air supply system for the combustion engine and a second air supply system for the fuel cell, said two systems being separate and independent of one another. However, such a configuration has proved bulky and requires the installation of a large number of components, generating significant additional costs.

Application WO2015193111 A1 concerns a hydrogen storage unit for the supply of hydrogen to an internal combustion engine and to a fuel cell. An air intake system is provided for the internal combustion engine and the fuel cell.

The air supply system of the fuel cell comprises an air compressor associated with an electric motor, and a 3-way valve. However, this document does not describe the following characteristics:
a 3-way valve which directs the air flow of the fuel cell towards a silencer at the outlet of the fuel cell, or the oxygen-depleted air towards the air inlet of the internal combustion engine,
an air supply system comprising an air filter for the fuel cell, and an air filter and a silencer for the internal combustion engine.

A powertrain according to the invention combines an internal combustion engine supplied with hydrogen and an electric motor supplied by a fuel cell, in which the air supply for said internal combustion engine and for the fuel cell has been improved.

The object of the invention is a powertrain operating with hydrogen, said powertrain comprising a hydrogen tank, an internal combustion engine supplied with hydrogen by said hydrogen tank, and an electric motor operating from a fuel cell supplied with hydrogen originating from this hydrogen tank.

According to the invention, the powertrain comprises a first air-circulation circuit opening into an air inlet of the fuel cell so as to supply air to said fuel cell, and an air-circulation connecting circuit which is equipped with an opening/closing means and connects an air outlet of the fuel cell to an air inlet of the internal combustion engine, in order to allow the oxygen-depleted air originating from the fuel cell to supply the internal combustion engine, the internal combustion engine being supplied with air by a second air-circulation circuit. In this way, thanks to the beneficial presence of the air-circulation connecting circuit between the fuel cell and the internal combustion engine, said internal combustion engine can benefit from the depleted air originating from the fuel cell. In fact, the air leaving the fuel cell is oxygen-depleted because a part of the oxygen present at the inlet of said cell has been consumed for the production of the electrical power. This oxygen-depleted air may be conducted towards the air inlet of the internal combustion engine, allowing said internal combustion engine to operate with the oxygen-depleted air. This operation allows the use of the internal combustion engine at a richness 1, since there will no longer be any oxygen at the outlet from the engine, while benefiting from a diluted intake air, the O2/N2 ratio being reduced relative to that of the exterior air. The opening/closing means, which may for example be represented by a three-way valve, can be controlled independently, either to allow the oxygen-depleted air originating from the fuel cell to be conducted towards an air inlet of the internal combustion engine, or to interrupt the circulation of this oxygen-depleted air between said fuel cell and said internal combustion engine. A powertrain according to the invention may thus operate in three different ways:
either only with the fuel cell, and in this case the opening/closing means of the connecting circuit is in a closed position, the fuel cell being supplied with air by the first circuit,
or only with the combustion engine alone, and in this case the opening/closing means of the connecting circuit is in a closed position, said internal combustion engine operating only with the air originating from the second air-circulation circuit,
or by combining operation with the fuel cell and operation with the internal combustion engine, in order to allow said internal combustion engine to benefit from the oxygen-depleted air originating from the fuel cell, and in this case the opening/closing means of the air-circulation connecting circuit is in an open position.

According to a possible characteristic of the invention, the first air-circulation circuit comprises an air inlet, a first air filter and a first air compressor, these three elements being arranged upstream of the fuel cell relative to the direction of movement of the air in said first circuit in order to supply compressed air to said cell. This first air circuit allows the injection of pressurized air originating from the exterior of the vehicle into the fuel cell.

According to a possible characteristic of the invention, the first air compressor is associated with a first electric motor. The injection of pressurized air into the fuel cell takes place autonomously, provoked by an activation of the first electric motor.

According to a possible characteristic of the invention, the opening/closing means is a three-way valve placed between the air outlet of the fuel cell and the air inlet of the internal combustion engine, said three-way valve occupying a first position in which it directs the air flow originating from the fuel cell towards the air inlet of the internal combustion engine, or a second position in which it directs the air flow originating from the fuel cell towards a silencer. This three-way valve thus allows either the oxygen-depleted air originating from the fuel cell to be conducted towards an air inlet of the internal combustion engine, or this oxygen-depleted air to be conducted towards a silencer without supplying the internal combustion engine. The silencer is placed on an evacuation pipe for the oxygen-depleted gas originating from the fuel cell, which pipe is separate from the connecting circuit.

According to a possible characteristic of the invention, the air-circulation connecting circuit comprises a control valve placed between the three-way valve and the air inlet of the internal combustion engine, said control valve occupying a first position in which it allows the circulation of oxygen-depleted air towards said air inlet, or a second position in which it blocks said circulation of depleted air. In this way, if the three-way valve is in an open position to allow passage of the oxygen-depleted air originating from the fuel cell towards the internal combustion engine, this control valve allows interruption of the circulation of this oxygen-depleted air originating from the three-way valve at any time. This control valve allows a finer control of the circulation conditions of the oxygen-depleted air flow, in particular towards the internal combustion engine. This control valve advantageously supplements the three-way valve.

According to a possible characteristic of the invention, the second air-supply circuit comprises a second air inlet, a second air filter, a second air compressor and a cooler. This second air circuit allows injection of the cooled and pressurized air originating from outside the vehicle into the internal combustion engine.

According to a possible characteristic of the invention, the air inlet of the internal combustion engine, into which the connecting circuit for circulation of air originating from the fuel cell opens, is connected to the second air-circulation circuit in a duct connecting the second air filter and the second air compressor.

According to a possible characteristic of the invention, the powertrain comprises an air-exhaust circuit starting at an air outlet of the internal combustion engine, said air-exhaust circuit comprising a turbine which is coupled to the second air compressor and supplied by the air flow leaving said internal combustion engine.

According to a possible characteristic of the invention, the exhaust circuit comprises a silencer situated between the turbine and an air outlet of said exhaust circuit. The exhaust gases emitted by the internal combustion engine are evacuated towards the exterior of the vehicle via the silencer.

According to a possible characteristic of the invention, the powertrain comprises a buffer battery intended to supplement the fuel cell in order to ensure the operation of the electric motor.

A powertrain according to the invention has the advantage of being able to operate in three different modes, namely with the fuel cell alone, with the internal combustion engine alone, or with a combination of said cell and said engine, thanks to the beneficial installation of an air-circulation connecting circuit between the fuel cell and the internal combustion engine. In this way, the mode combining the fuel cell and the internal combustion engine allows said engine to operate with the oxygen-depleted air originating from said cell, and allows a gain to be achieved in:
the aftertreatment architecture, relative to an aftertreatment architecture for a combustion engine operating at richness 1 or with a lean mixture,
the engine efficiency, since it functions with a diluted mixture. It is therefore possible to benefit from the advantage of dilution for the engine efficiency, without the drawbacks of aftertreatment systems with a lean mixture.

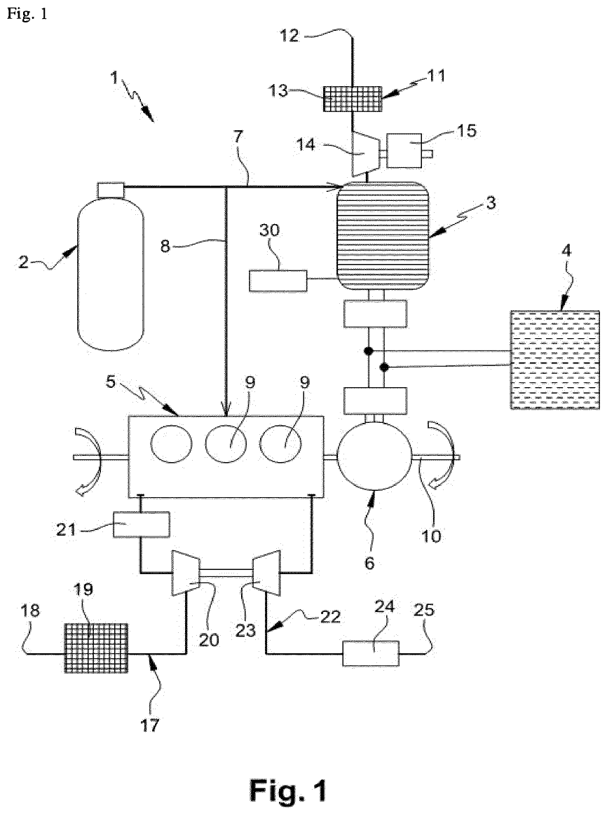

A detailed description is given below of a preferred embodiment of a powertrain according to the invention, with reference to the following figures:
FIG. 1 shows a simplified schematic view of a powertrain according to the prior art.

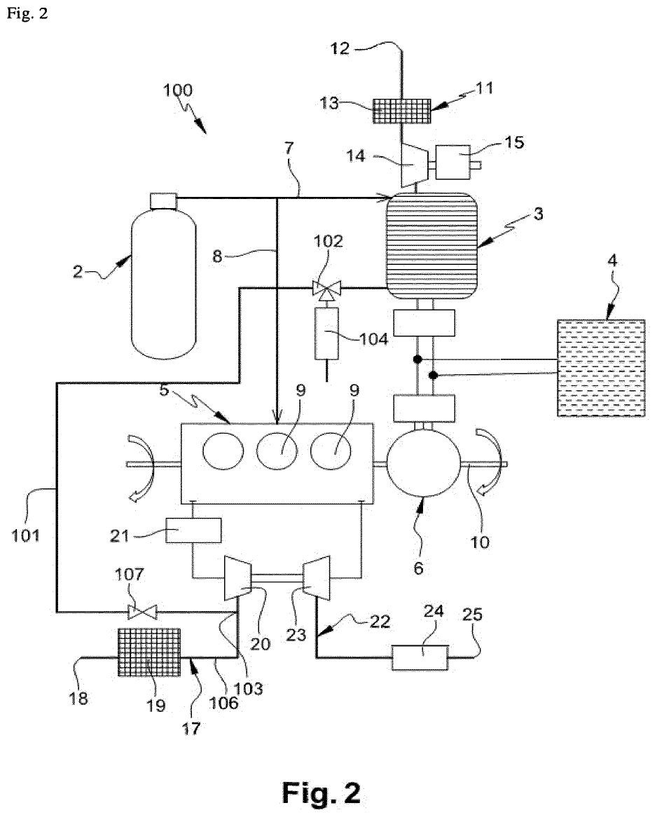

FIG. 2 shows a simplified diagram of a powertrain according to the invention.

With reference to FIG. 1, a powertrain 1 according to the prior art comprises a hydrogen tank 2, a fuel cell 3, a buffer battery 4, an internal combustion engine 5 operating with hydrogen, and an electric motor 6. The hydrogen tank 2 may be represented, for example, by at least one pressurized hydrogen cylinder. A first duct 7 connects the hydrogen tank 2 to the fuel cell 3 in order to supply the hydrogen coming from the tank 2 to the fuel cell 3. A second duct 8 starts from the first duct 7 upstream of the fuel cell 3 and extends up to the internal combustion engine 5, said second duct 8 allowing the hydrogen coming from the tank 2 to be conducted towards said internal combustion engine 5. The internal combustion engine 5 conventionally comprises combustion chambers 9. Thanks to the fuel cell 3 supplemented by the buffer battery 4, the operation of the electric motor 6 can be ensured. The internal combustion engine 5 operating with hydrogen and the electric motor 4 are both connected to a transmission axle 10 of the vehicle, which can be set in rotation by at least one of said two motors 4, 5 in order to propel the vehicle.

The fuel cell 3 is supplied with the air from outside the vehicle via a first air-circulation circuit 11. This first air-circulation circuit 11 comprises, in this order, a first air inlet 12, a first air filter 13, and a first air compressor 14 operating with an autonomous electric motor 15. The first filter 13 cleans the air originating from the first inlet 12, before it is compressed by the first compressor 14 then injected into the fuel cell 3. The first air-circulation circuit 11 allows injection of the pressurized air into the fuel cell 3 in order to ensure its operation, this air then being evacuated via an outlet duct 16 which starts from said fuel cell 3 and ends at a silencer 30.

The internal combustion engine 5 is supplied with air from outside the vehicle via a second air-circulation circuit 17. This second circuit 17 comprises, in this order, a second air inlet 18, a second air filter 19, a second compressor 20, and a cooler 21 placed just before the internal combustion engine 5. The second filter 19 cleans the air originating from the second inlet 18, before it is compressed by the second compressor 20 and then cooled by the cooler 21.

The compressed and cooled air coming from the cooler 21 is then injected into the combustion chambers 9 of the internal combustion engine 5. The exhaust gases are then evacuated from the combustion chambers 9 by means of an exhaust circuit 22 comprising a turbine 23, which is coupled to the second compressor 20, a silencer 24 and an air outlet 25, said silencer 24 being placed between said turbine 23 and said air outlet 25.

For such a configuration of a powertrain 1, the internal combustion engine 5 and the electric motor 4 (via the fuel cell 3) operate simultaneously, both being supplied with air originating from outside the vehicle in which the powertrain is installed.

With reference to FIG. 2, a powertrain 100 according to the invention differs from the above-described powertrain 1 of the prior art in that the outlet duct 16 of the fuel cell 3 no longer terminates at the silencer 30 but is extended up to the internal combustion engine 5, in order to form an air-circulation connecting duct 101 between said internal combustion engine 5 and said fuel cell 3. This connecting duct 101 comprises a three-way valve 102, which can occupy a first position in which it directs the air flow originating from the fuel cell 3 towards an air inlet 103 of the internal combustion engine 5, and a second position in which it directs the air flow originating from the fuel cell 3 towards an evacuation branch for oxygen-depleted air, which is equipped with a silencer 104. The air inlet 103 of the internal combustion engine 5 is situated on an air-circulation duct 106 connecting the second air filter 19 and the second compressor 20 of the second air-circulation circuit 17. In other words, the air-circulation connecting duct 101 connecting the fuel cell 3 and the internal combustion engine 5 opens into the air-circulation duct 106 connecting the second air filter 19 and the second compressor 20 of the second air-circulation circuit 17. A control valve 107 is situated on the connecting duct 101 between the three-way valve 102 and the air inlet 103 of the internal combustion engine 5, wherein said control valve 107 can occupy:
a first position in which it allows the oxygen-depleted air circulating in the connecting duct 101 to be directed towards the air inlet 103 of the internal combustion engine 5, or
a second position in which it blocks said circulation of air in the connecting duct 101, preventing the oxygen-depleted air from entering said internal combustion engine 5.

The original feature of a powertrain 100 according to the invention is that the internal combustion engine 5 operating with hydrogen is able to benefit, during certain travel phases of the vehicle, from oxygen-depleted air originating from the fuel cell 3. In fact, the air leaving the fuel cell 3 is oxygen-depleted because a part of the oxygen present at the inlet to said cell 3 has been consumed for the production of electrical power. Thanks to this supply with oxygen-depleted air, the internal combustion engine 5 may be used at richness 1, i.e. there will no longer be any oxygen at the outlet from said engine 5, while benefiting from a diluted intake air since the O2/N2 ratio is reduced relative to that of the ambient exterior air. This operating mode with the oxygen-depleted air allows a gain to be achieved in:
the aftertreatment architecture, relative to an aftertreatment architecture for a combustion engine operating at richness 1 or with a lean mixture,
the engine efficiency, since it functions with a diluted mixture. It is therefore possible to benefit from the advantage of dilution for the engine efficiency, without the drawbacks of aftertreatment systems with a lean mixture.

1-10. (canceled)

11. A powertrain operating with hydrogen, said powertrain comprising:
a hydrogen tank;
an internal combustion engine supplied with the hydrogen by said hydrogen tank;
an electric motor operating from a fuel cell supplied with the hydrogen originating from the hydrogen tank;
a first air-circulation circuit opening into an air inlet of the fuel cell so as to supply air to said fuel cell; and
an air-circulation connecting circuit that is equipped with an opening/closing means and connects an air outlet of the fuel cell to an air inlet of the internal combustion engine in order to allow oxygen-depleted air originating from the fuel cell to supply the internal combustion engine, the internal combustion engine being supplied with air by a second air-circulation circuit.

12. The powertrain as claimed in claim 11, wherein the first air-circulation circuit comprises an air inlet, a first air filter, and a first air compressor, and the air inlet, the first air filter, and the first air compressor of the first air-circulation circuit are arranged upstream of the fuel cell relative to a direction of movement of the air in said first circuit in order to supply compressed air to said cell.

13. The powertrain as claimed in claim 12, wherein the first air compressor is associated with a first electric motor.

14. The powertrain as claimed in claim 12, wherein the opening/closing means is a three-way valve placed between the air outlet of the fuel cell and the air inlet of the internal combustion engine, and said three-way valve occupies a first position in which said three-way valve directs the air flow originating from the fuel cell towards the air inlet of the internal combustion engine, or a second position in which said three-way valve directs the air flow originating from the fuel cell towards a silencer.

15. The powertrain as claimed in claim 14, wherein the air-circulation connecting circuit comprises a control valve placed between the three-way valve and the air inlet of the internal combustion engine, and said control valve occupies a first position in which said control valve allows circulation of the oxygen-depleted air towards said air inlet or a second position in which said control valve blocks said circulation of depleted air.

16. The powertrain as claimed in claim 11, wherein the second air-circulation circuit comprises a second air inlet, a second air filter, a second air compressor, and a cooler.

17. The powertrain as claimed in claim 16, wherein the air inlet of the internal combustion engine, into which the connecting circuit for circulation of air originating from the fuel cell opens, is connected to the second air-circulation circuit in a duct connecting the second air filter and the second air compressor.

18. The powertrain as claimed in claim 16, further comprising an air-exhaust circuit starting at an air outlet of the internal combustion engine, wherein said air-exhaust circuit comprises a turbine which is coupled to the second air compressor and supplied by the air flow leaving said internal combustion engine.

19. The powertrain as claimed in claim 18, wherein the exhaust circuit comprises a silencer situated between the turbine and an air outlet of said exhaust circuit.

20. The powertrain as claimed in claim 11, further comprising a buffer battery configured to supplement the fuel cell in order to ensure the operation of the electric motor.
